(19) United States
(12) Patent Application Publication
(10) Pub. No.: US 2017/0164357 A1
(43) Pub. Date: Jun. 8, 2017

(54) Automated Diplomatic Interactions For Multiple Users Of A Shared Device

(71) Applicant: AT&T INTELLECTUAL PROPERTY I, LP, Atlanta, GA (US)

(72) Inventors: JAMES FAN, SAN RAMON, CA (US); JEFFREY A. AARON, Atlanta, GA (US); VENSON SHAW, KIRKLAND, WA (US)

(21) Appl. No.: 14/962,717

(22) Filed: Dec. 8, 2015

(51) Int. Cl. H04W 72/04; H04L 29/06; H04L 29/08

(52) U.S. Cl. CPC H04W 72/0446; H04L 67/327; H04L 65/601; H04L 67/306

(57) ABSTRACT

Aspects of the subject disclosure may include, for example, machine-readable storage medium, including executable instructions that, when executed by a processor, facilitate performance of operations, including configuring a display device to present a first data stream viewable only by a first viewer, configuring the display device to present a second data stream viewable only by a second viewer, wherein the first data stream and the second data stream have concurrent presentation schedules on the display device, and obtaining first personalized content according to a first behavior profile of the first viewer and second personalized content according to a second behavior profile of the second viewer, wherein the first personalized content differs from the second personalized content.

### RELATED APPLICATION(S)

U.S. patent application Ser. No. 12/828,201, filed Jun. 30, 2010, by Tory Meuninck et al., entitled “Method and Apparatus for Delivering Media Content” is hereby incorporated by reference. All sections of the aforementioned application are incorporated herein by reference in its entirety.

### FIELD OF THE DISCLOSURE

The subject disclosure relates to a system for automated diplomatic interactions for multiple users of a shared device.

### BACKGROUND

Display devices can present multiple-content outputs so as to allow two or more viewers to watch and/or listen to different content from the same display device. By utilizing one of polarization or assigning time slots to images on the screen of a display device, each viewing apparatus associated with the display device can show an image to an eye of the wearer of the viewing apparatus so that each user is only aware of media content presented for that user.

### BRIEF DESCRIPTION OF THE DRAWINGS

Reference will now be made to the accompanying drawings, which are not necessarily drawn to scale, and wherein:

FIG. 1 depicts an illustrative embodiment of a presentation device and media processor for presenting media content;

FIG. 2 depicts an illustrative embodiment of a viewing apparatus;

FIG. 3 depicts an illustrative embodiment of a presentation device with a polarized display;

FIG. 4 depicts an illustrative embodiment of a method used in portions of the system described in FIG. 1;

FIG. 5 depicts illustrative an embodiment of a communication system that provide media services to the systems of FIGS. 1-3;

FIG. 6 depicts an illustrative embodiment of a web portal for interacting with the communication systems of the presentation systems of FIGS. 1-3 and the communications system of FIG. 5;

FIG. 7 depicts an illustrative embodiment of a communication device; and

FIG. 8 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for allowing users to view different versions of content from the same presentation device. Other embodiments are described in the subject disclosure.

One or more aspects of the subject disclosure include method that includes detecting, by a media processor comprising a processor, a plurality of viewing devices in communication with a display device, transmitting, by the media processor, a synchronization signal to a first viewing device of the plurality of viewing devices and a second viewing device of the plurality of viewing devices, configuring, by the media processor, the display device to present a first data stream viewable only by the first viewing device, configuring, by the media processor, the display device to present a second data stream viewable only by the second viewing device, wherein the first data stream and the second data stream have overlapping presentation schedules on the display device, obtaining, by the media processor, first media content for the first viewing device and second media content for the second viewing device, wherein the first media content and the second media content comprise a same media program, adjusting, by the media processor, the first media content to generate first personalized content provided to the display device for presentation to the first viewing device, and adjusting, by the media processor, the second media content to generate second personalized content provided to the display device for presentation to the second viewing device, wherein the first personalized content and the second personalized content no longer comprise the same media program.

One or more aspects of the subject disclosure include an apparatus that includes a processor and a memory that stores executable instructions that, when executed by the processor, facilitate performance of operations that include transmitting a synchronization signal to a first viewing apparatus and a second viewing apparatus, wherein the synchronization signal enables the first viewing apparatus to present a first presentation viewable only by a first user of the first viewing apparatus and enables the second viewing apparatus to present a second presentation viewable only by a second user of the second viewing apparatus, adapting the display device to present a first data stream viewable only by the first viewing apparatus, adapting the display device to present a second data stream viewable only by the second viewing apparatus, and wherein the first and the second data streams are provided simultaneously to the display device, obtaining first personalized content for the first viewing apparatus according to a first viewer profile of the first user and second personalized content for the second viewing apparatus according to a second viewer profile of the second user, wherein the first personalized content and the second personalized content differ from each other, providing the first personalized content to the display device for presentation at the first viewing apparatus, and providing the second personalized content to the display device for presentation at the second viewing apparatus.

One or more aspects of the subject disclosure include a machine-readable storage medium, comprising executable instructions that, when executed by a processor, facilitate performance of operations that include configuring a display device to present a first data stream viewable only by a first viewer, configuring the display device to present a second data stream viewable only by a second viewer, wherein the first data stream and the second data stream have concurrent presentation schedules on the display device, and obtaining first personalized content according to a first behavior profile of the first viewer and second personalized content according to a second behavior profile of the second viewer, wherein the first personalized content differs from the second personalized content.

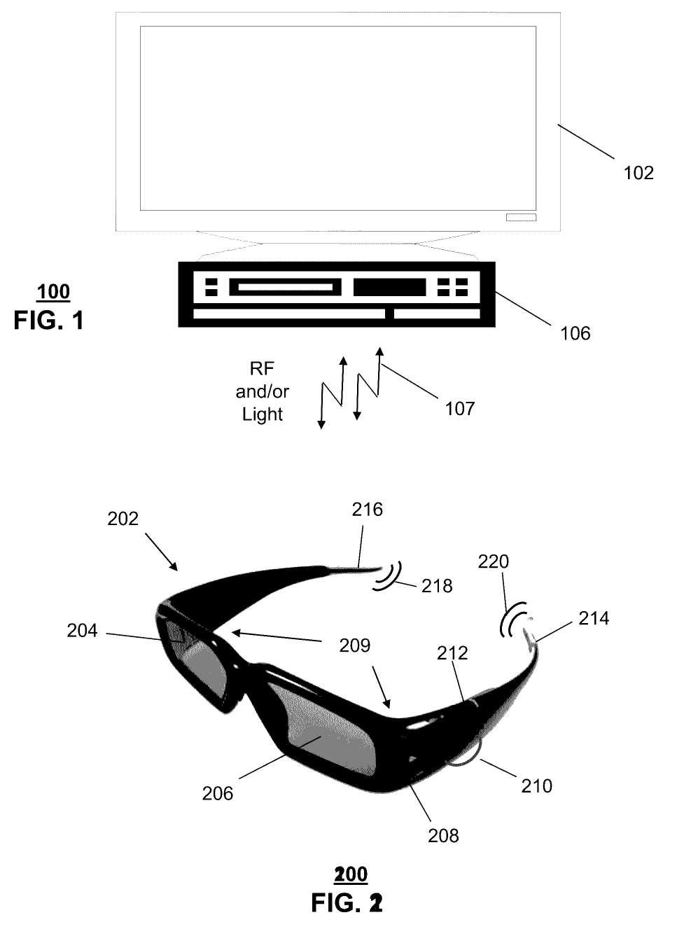

FIG. 1 depicts an illustrative embodiment of a presentation device 102 and a media processor 106 for presenting media content. In the present illustration, the presentation device 102 is depicted as a television set. It will be appreciated that the presentation device 102 alternatively can represent a portable communication device such as a cellular phone, a PDA, a computer, or other computing device with the ability to display media content. The media processor 106 can be an STB such as illustrated in FIG. 1, or some other computing device such as a cellular phone, computer, gaming console, or other device that can process and direct the presentation device 102 to emit images associated with media content. It is further noted that the media processor 106 and the presentation device 102 can be an integral unit. For example, a computer or cellular phone having computing and display resources collectively can represent the combination of a presentation device 102 and media processor 106.

The media processor 106 can be adapted to communicate with accessories such as the viewing apparatus 202 of FIG. 2 by way of a wired or wireless interface 107. A wired interface can represent a tethered connection from the viewing apparatus to an electro-mechanical port of the media processor 106 (e.g., USB or proprietary interface). A wireless interface can represent a radio frequency (RF) interface such as Bluetooth, WiFi, Zigbee or other wireless standard. The wireless interface can also represent an infrared communication interface. Any standard or proprietary wireless interface between the media processor 106 and the viewing apparatus 202 is contemplated by the presented disclosure.

The viewing apparatus 202 can represent an apparatus for viewing two-dimensional (2D) or three-dimensional (3D) stereoscopic images which can be still or moving images. The viewing apparatus 202 can be an active shutter viewing apparatus. In this embodiment, each lens has a liquid crystal layer which can be darkened or made to be transparent by the application of one or more bias voltages. Each lens 204, 206 can be independently controlled. Accordingly, the darkening of the lenses 204, 206 can alternate, or can be controlled to operate simultaneously.

Each viewing apparatus 202 can include all or portions of the components of the communication device 700 illustrated in FIG. 7. For example, the viewing apparatus 202 can utilize the receiver portion of the transceiver 702 in the form of an infrared receiver depicted by the window 208. Alternatively, the viewing apparatus 202 can function as a two-way communication device, in which case a full infrared transceiver could be utilized to exchange signals between the media processor 106 and the viewing apparatus 202. It is contemplated that the transceiver 702 can be replaced with a unidirectional RF receiver or a bidirectional RF transceiver.

Window 208 can also include one or more common light sensors that measure ambient light and/or measure light signals supplied from the presentation device 102. Alternatively or in combination, one or more light sensors can also be placed on an inner portion 209 of the viewing apparatus 202 to measure light supplied by the optical elements 204, 206 or reflections of light from a user's eyes (e.g., sclera or eyelid flesh). The measurements of light generate illumination information which can be transmitted to the media processor 106.

The viewing apparatus 202 can utilize a controller 706 to control operations thereof, and a portable power supply (not shown), The viewing apparatus 202 can have portions of the UI 704 of FIG. 7. For example, the viewing apparatus 202 can have a multi-purpose button 212 which can function as a power on/off button and as a channel selection button. A power on/off feature can be implemented by a long-duration depression of button 212 which can toggle from an on state to an off state and vice-versa. Fast depressions of button 212 can be used for channel navigation. Alternatively, two buttons can be added to the viewing apparatus 202 for up/down channel selection, which operate independent of the on/off power button 212. In another embodiment, a thumbwheel can be used for scrolling between channels. Additional buttons, a scroll wheel or other common manipulative devices (not shown) can be added to the viewing apparatus 202 to also control light intensity produced by the presentation device 102. For example increase and decrease buttons can be used to submit illumination requests to the media processor 106 over a wireless or wired medium as previously described. Alternatively or in combination any of the aforementioned functions of the user interface 704 of the viewing apparatus can be controlled by speech detection.

It is further noted that illumination information generated by the light sensor and requests for a change in light intensity can be submitted in combination to the media processor 106, presentation device 102 or combinations thereof.

The viewing apparatus 202 can also include an audio system 712 with one or more speakers in the extensions of the housing assembly such as shown by references 216, 214 to produce localized audio 218, 220 near a user's ears. Different portions of the housing assembly can be used to produce mono, stereo, or surround sound effects. Ear cups (not shown) such as those used in headphones can be used by the viewing apparatus 202 (as an accessory or integral component) for a more direct and low-noise audio presentation technique. The volume of sound presented by the speakers 214, 216 can be controlled by a thumbwheel 210 (or up/down buttons not shown).

It would be evident from the above descriptions that many embodiments of the viewing apparatus 202 are possible, all of which are contemplated by the present disclosure.

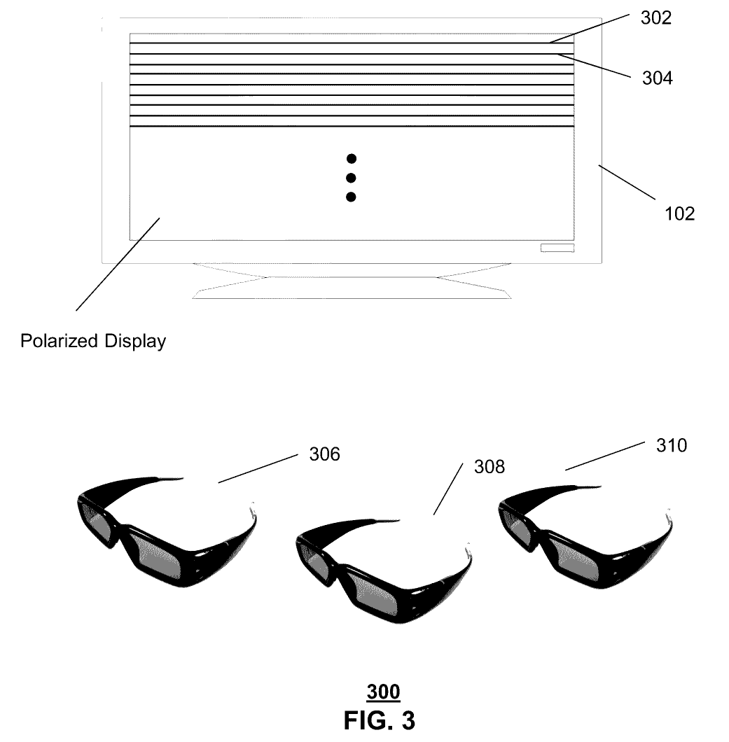

FIG. 3 depicts an illustrative embodiment of the presentation device 102 of FIG. 1 with a polarized display. A display can be polarized with polarization filter technology so that alternative pixel rows can be made to have differing polarizations. For instance, odd pixels rows 302 can be polarized for viewing with one polarization filter, while even pixels rows 304 can be polarized for viewing with an alternative polarization filter. The viewing apparatus 202 of FIG. 2 can be adapted to have one lens polarized for odd pixel rows, while the other lens is polarized for viewing even pixel rows. With polarized lenses, the viewing apparatus 202 can present a user a 3D stereoscopic image.

In addition, presentation device 102 can use the differing time slots or polarization of the viewing apparatuses to present different programs to each of the viewing apparatuses associated with the presentation device 102. For example, in FIG. 3, presentation device 102 may be associated with three different viewing apparatuses 306, 308, and 310. Each one of viewing apparatuses 306, 308, and 310 can utilize the time-shift or polarization of the presentation device 102 to present different audio and visual content to each user or wearer of the viewing apparatuses 306, 308, and 310. Furthermore, unused time slots can be utilized to increase an available light intensity by showing additional frames of images through the viewing apparatus to its respective user.

Once a media program selection has been detected for each shutter glass, the STB 106 can direct the display device to emit images of each program according to the time slots assigned to each set of viewing apparatus. In addition, in an instance where two users, Users 1 and 2, wear the respective viewing apparatuses, time-synchronized audio signals can be transmitted to the viewing apparatus of Users 1 and 2. The viewing apparatus can each process the audio signal with a built-in audio system for presenting audio associated with the selected program by way of the audio speakers located on the viewing apparatus. Volume can be controlled at each of the viewing apparatus by way of a volume controller provided for each viewing apparatus.

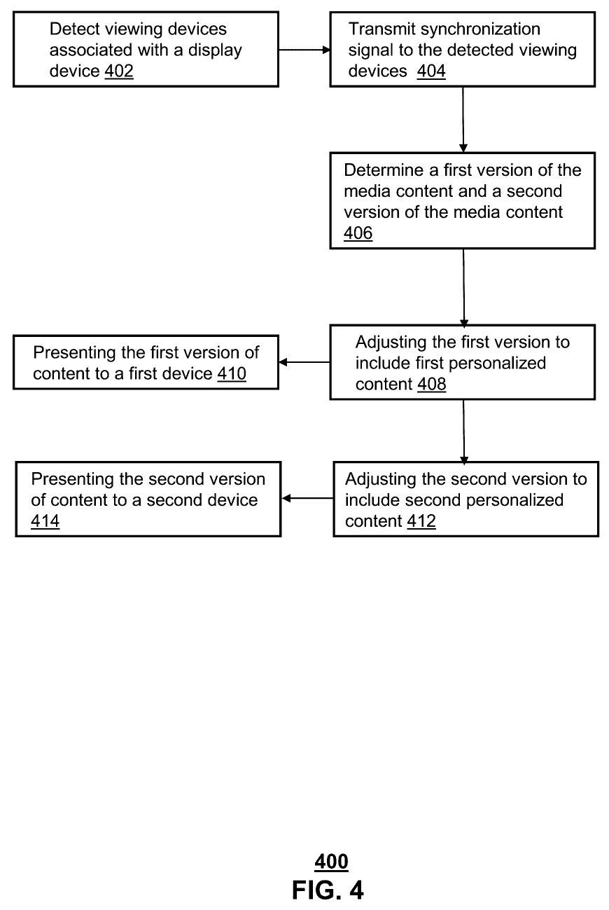

FIG. 4 depicts an illustrative embodiment of a method 400 used by the presentation system illustrated in FIGS. 1-3. Method 400 begins by a display device or media processor associated with a display device, such as presentation device 102 of FIG. 1, determining how many viewing apparatuses are associated with the display device in Step 402. For example, as exemplarily illustrated in FIG. 3, presentation device 102 can be associated with three different viewing apparatuses such as viewing apparatuses 306, 308, and 310. Exemplarily, the viewing apparatus can be detected and then a user associated with the viewing apparatus can be determined. Once detected, synchronization signals for as viewing apparatus 306, 308, and 310 can be generated in Step 404. The synchronization signals enable each viewing apparatus to show only the content on the display device intended for a user while it is displayed on the display device so as to create images that the user can see. Additionally, the change in a viewer for a viewing apparatus can be detected and the change in viewership can be used to appropriately update the media content as discussed below in Step 406.

Assuming, for example, that two viewing apparatus have been detected, in Step 406, different versions of the media content would be determined. That is, exemplarily, each viewing apparatus is associated with the user. For example, a cell phone or other communication device on the person of the user can be detected and the user is identified via the communications device. In other embodiments, the user can register with the viewing device itself via a voice activation process. In yet further embodiments, the user can be recognized visually by a camera embedded in the viewing apparatus.

Once the user is determined and associated with a viewing device, the system can determine what version of the media content would be shown to the user. Exemplarily, a first user and a second user would choose to watch the same episode of television or movie. However, each user could then customize their viewing experience. For example, in some embodiments, the customization could change the volume or visual presentation options for the media content. That is, the sharpness, contrast, or other customization of the image can be controlled for the user.

Exemplarily, the set-top box or other media processors can be provided with alternative versions or segments of the media content. The alternative content can include “clean” soundtracks. The alternative content could include segments without certain images or sequences. The media processor can decide which user gets to view which segment, soundtrack, or version of the media content.

In other embodiments, the various users assembled for viewing the presentation device can decide which version of the media content they will watch. Exemplarily, the media content has several options as to how to be watched. That is, several versions can be selected from. For example, the users can be presented with various levels of parental supervision or content filtering. Thus, users can be assigned a G-version for one user and PG-13 for another. Furthermore, one user can set parental controls for another user so that forbidden words or images can be automatically removed from the content, or a replacement soundtrack or image can be inserted in their place. Furthermore, in some embodiments, the parent can view what the child is viewing in order to gauge how appropriate the content is. In addition, viewers can have the option to share the content version they are viewing with other viewers. In additional embodiments, forbidden words for a user can be edited out or changed on the fly as needed. Similarly, in other embodiments, images that are forbidden for a user can likewise be replaced in real-time or through alternate versions of the content available.

Next, in Steps 408 and 412, the personalized content for each user can be determined. The personalized content can include the separate versions of the media content or customized viewing settings discussed above. In additional embodiments, the personalized content can include advertisements intended specifically for each user. For example, when a user selects a viewing apparatus, a profile can be accessed or generated for that user to determine various preferences and demographic statistics so to determine marketing and advertising options preferable for that user. Later, the set-top box 106 can use the user's profile information to obtain advertising for that user and present that advertising to the user through the display device and viewing apparatus. Finally, in Steps 410 and 414, the personalized media content can be presented to each viewer through their respective viewing apparatuses so as to provide each user with a custom presentation of the media content.

In some embodiments, while presenting the same media content to each user wearing a viewing apparatus for a display device, the set-top box 106 or the display device 102 itself can be configured to provide each user with a respective customized viewing experience. Thus, based on the user's preferences, different visual customization settings are obtained and presented. In additional embodiments, the user can be presented with different versions of the same media content based on the user's profile, preferences, or demographics, such as the age of the user. In further embodiments, the user can he presented with different advertising content generated or obtained for that user during the same media content presentation. The advertising can be in the form of different traditional advertising content. Additional embodiments can instead insert into the media content itself, product placements and other background advertising images specifically for that user. Thus, User 1 may observe a character drink a beer of a certain brand while a younger User 2 may observe the same character drink milk or a soda of a particular brand in the same scene. Additionally, User 1 may observe a background image with a first product while User 2 observes a background image of a different product customized according to User 2's profile.

In additional embodiments, outside interactions can occur through a user's viewing apparatus that appear only to that user while all the users watch the same media content from the display device. For example, one user can observe a telepresence session during the program, such as a voice call or a video chat. In other examples, the user can be notified of social media activities, such as receiving an email, text, or a comment. These outside interactions can appear only to the user to which the interaction is directed.

While for purposes of simplicity of explanation, the respective processes are shown and described as a series of blocks in FIG. 4, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

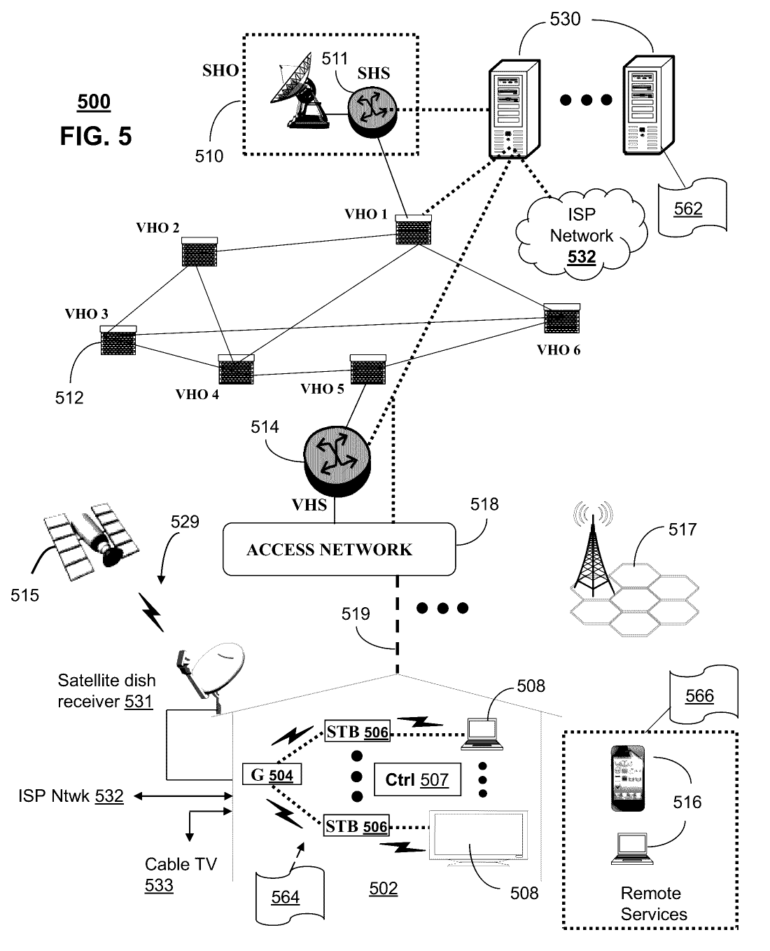

FIG. 5 depicts an illustrative embodiment of a first communication system 500 for delivering media content. The communication system 500 can represent an Internet Protocol Television (IPTV) media system. Communication system 500 can be overlaid or operably coupled with the set-top box or media processor 106 and display devices of FIGS. 1-3 as another representative embodiment of communication system 500. For instance, one or more devices illustrated in the communication system 500 of FIG. 5 can perform a method that includes detecting, by a media processor comprising a processor, a plurality of viewing devices in communication with a display device, transmitting, by the media processor, a synchronization signal to a first viewing device of the plurality of viewing devices and a second viewing device of the plurality of viewing devices, configuring, by the media processor, the display device to present a first data stream viewable only by the first viewing device, configuring, by the media processor, the display device to present a second data stream viewable only by the second viewing device, wherein the first data stream and the second data stream have overlapping presentation schedules on the display device, obtaining, by the media processor, first media content for the first viewing device and second media content for the second viewing device, wherein the first media content and the second media content comprise a same media program, adjusting, by the media processor, the first media content to generate first personalized content provided to the display device for presentation to the first viewing device, and adjusting, by the media processor, the second media content to generate second personalized content provided to the display device for presentation to the second viewing device, wherein the first personalized content and the second personalized content no longer comprise the same media program.

The IPTV media system can include a super head-end office (SHO) 510 with at least one super headend office server (SHS) 511 which receives media content from satellite and/or terrestrial communication systems. In the present context, media content can represent, for example, audio content, moving image content such as 2D or 3D videos, video games, virtual reality content, still image content, and combinations thereof. The SHS server 511 can forward packets associated with the media content to one or more video head-end servers (VHS) 514 via a network of video head-end offices (VHO) 512 according to a multicast communication protocol. In other embodiments, a satellite based distribution system can be used so that the media content is delivered to the media processor through a satellite reception device.

The VHS 514 can distribute multimedia broadcast content via an access network 518 to commercial and/or residential buildings 502 housing a gateway 504 (such as a residential or commercial gateway). The access network 518 can represent a group of digital subscriber line access multiplexers (DSLAMs) located in a central office or a service area interface that provide broadband services over fiber optical links or copper twisted pairs 519 to buildings 502. The gateway 504 can use communication technology to distribute broadcast signals to media processors 506 such as Set-Top Boxes (STBs) which in turn present broadcast channels to media devices 508 such as computers or television sets managed in some instances by a media controller 507 (such as an infrared or RF remote controller).

The gateway 504, the media processors 506, and media devices 508 can utilize tethered communication technologies (such as coaxial, powerline or phone line wiring) or can operate over a wireless access protocol such as Wireless Fidelity (WiFi), Bluetooth®, Zigbee®, or other present or next generation local or personal area wireless network technologies. By way of these interfaces, unicast communications can also be invoked between the media processors 506 and subsystems of the IPTV media system for services such as video-on-demand (VoD), browsing an electronic programming guide (EPG), or other infrastructure services.

A satellite broadcast television system 529 can be used in the media system of FIG. 5. The satellite broadcast television system can be overlaid, operably coupled with, or replace the IPTV system as another representative embodiment of communication system 500. In this embodiment, signals transmitted by a satellite 515 that include media content can be received by a satellite dish receiver 531 coupled to the building 502. Modulated signals received by the satellite dish receiver 531 can be transferred to the media processors 506 for demodulating, decoding, encoding, and/or distributing broadcast channels to the media devices 508. The media processors 506 can be equipped with a broadband port to an Internet Service Provider (ISP) network 532 to enable interactive services such as VoD and EPG as described above.

In yet another embodiment, an analog or digital cable broadcast distribution system such as cable TV system 533 can be overlaid, operably coupled with, or replace the IPTV system and/or the satellite TV system as another representative embodiment of communication system 500. In this embodiment, the cable TV system 533 can also provide Internet, telephony, and interactive media services. System 500 enables various types of interactive television and/or services including IPTV, cable and/or satellite.

The subject disclosure can apply to other present or next generation over-the-air and/or landline media content services system.

Some of the network elements of the IPTV media system can be coupled to one or more computing devices 530, a portion of which can operate as a web server for providing web portal services over the ISP network 532 to wireline media devices 508 or wireless communication devices 516. Thus, for example, advertising content and additional media content can be provided to the set-top box of FIG. 1 to provide the directed content for each viewing apparatus of the display device.

Communication system 500 can also provide for all or a portion of the computing devices 530 to function as a directed content creator (herein referred to as directed content creator 530). The directed content creator 530 can use computing and communication technology to perform function 562, which can include among other things, the creation of personalized content and advertising for each viewing apparatus by method 400 of FIG. 4. For instance, function 562 of server 530 can be similar to the functions described of providing content to the set-top box. The media processors 506 and wireless communication devices 516 can be provisioned with software functions 564 and 566, respectively, to utilize the services of directed content creator 530. For instance, functions 564 and 566 of media processors 506 and wireless communication devices 516 can be similar to the functions described for the set-top box 106 of FIG. 1 in accordance with method 400.

Multiple forms of media services can be offered to media devices over landline technologies such as those described above. Additionally, media services can be offered to media devices by way of a wireless access base station 517 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LIE, and so on. Other present and next generation wide area wireless access network technologies can be used in one or more embodiments of the subject disclosure.

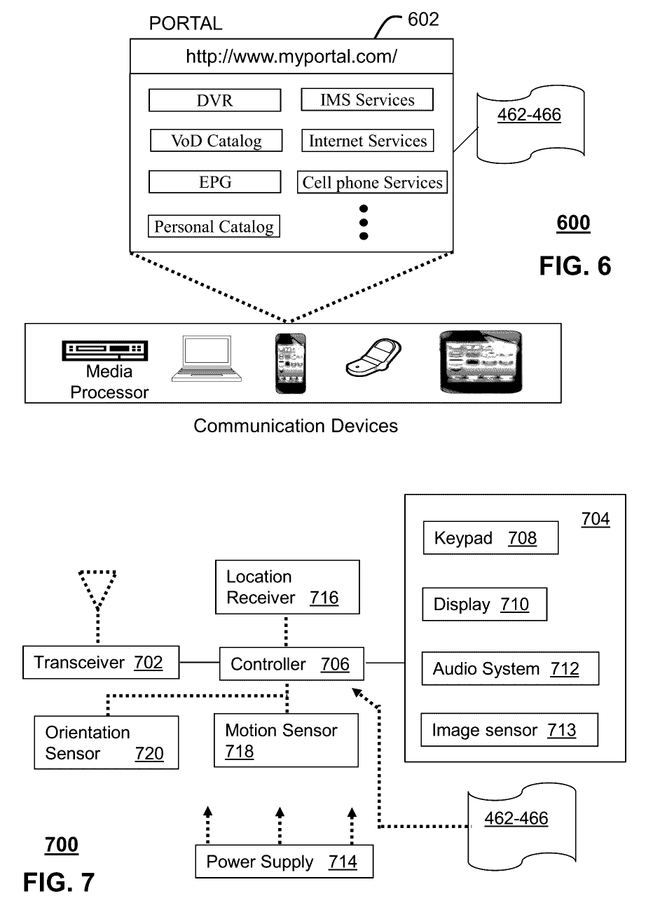

FIG. 6 depicts an illustrative embodiment of a web portal 602 of a communication system 600. Communication system 600 can be overlaid or operably coupled with system 100 of FIG. 1 and communication system 500 as another representative embodiment of the embodiments of FIGS. 1-3 and communication system 500. The web portal 602 can be used for managing services of system 100 of FIG. 1 and communication system 500. A web page of the web portal 602 can be accessed by a Uniform Resource Locator (URL) with an Internet browser using an Internet-capable communication device such as those described in FIG. 1 and FIG. 5. The web portal 602 can be configured, for example, to access a media processor 106 and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 106. The web portal 602 can also be used for provisioning IMS services described earlier, provisioning Internet services, provisioning cellular phone services, and so on.

The web portal 602 can further be utilized to manage and provision software applications 564 and 566 to adapt these applications as may be desired by subscribers and/or service providers of system 100 of FIG. 1 and communication system 500. For instance, viewers of the media content provided by the set-top box 106 or server 530 can log into their on-line accounts and provision the servers 110 or server 530 with their user profiles and respective preferences so as to provide information that can be used to generate advertising content for that user or to request specific versions of the media content to watch through their respective viewing apparatuses, and so on. Service providers can log onto an administrator account to provision, monitor and/or maintain the systems 100, 200, and 300 of FIGS. 1-3 or server 530.

FIG. 7 depicts an illustrative embodiment of a communication device 700. Communication device 700 can serve in whole or in part as an illustrative embodiment of the devices depicted in system 100 of FIG. 1 and communication system 500 and can be configured to perform portions of [method 400 of FIG. 4 such as controlling the set-top box, the display device, or the respective viewing apparatuses.

Communication device 700 can comprise a wireline and/or wireless transceiver 702 (herein transceiver 702), a user interface (UI) 704, a power supply 714, a location receiver 716, a motion sensor 718, an orientation sensor 720, and a controller 706 for managing operations thereof. The transceiver 702 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example. CDMA-1×, UMTS/HSDPA, GSM/GPRS, TDMA/EDGE, EV/DO, WiMAX SDR, LTE, as well as other next generation wireless communication technologies as they arise. The transceiver 702 can also be adapted to support circuit-switched wireline access technologies (such as PSTN), packet-switched wireline access technologies (such as TCP/IP, VoIP, etc.), and combinations thereof.

The UI 704 can include a depressible or touch-sensitive keypad 708 with a navigation mechanism such as a roller ball, a joystick, a mouse, or a navigation disk for manipulating operations of the communication device 700. The keypad 708 can be an integral part of a housing assembly of the communication device 700 or an independent device operably coupled thereto by a tethered wireline interface (such as a USB cable) or a wireless interface supporting for example Bluetooth®. The keypad 708 can represent a numeric keypad commonly used by phones, and/or a QWERTY keypad with alphanumeric keys. The UI 704 can further include a display 710 such as monochrome or color LCD (Liquid Crystal Display), OLED (Organic Light Emitting Diode) or other suitable display technology for conveying images to an end user of the communication device 700. In an embodiment where the display 710 is touch-sensitive, a portion or all of the keypad 708 can be presented by way of the display 710 with navigation features.

The display 710 can use touch screen technology to also serve as a user interface for detecting user input. As a touch screen display, the communication device 700 can be adapted to present a user interface with graphical user interface (GUI) elements that can be selected by a user with a touch of a finger. The touch screen display 710 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 710 can be an integral part of the housing assembly of the communication device 700 or an independent device communicatively coupled thereto by a tethered wireline interface (such as a cable) or a wireless interface.

The UI 704 can also include an audio system 712 that utilizes audio technology for conveying low volume audio (such as audio heard in proximity of a human ear) and high volume audio (such as speakerphone for hands free operation). The audio system 712 can further include a microphone for receiving audible signals of an end user. The audio system 712 can also be used for voice recognition applications. The UI 704 can further include an image sensor 713 such as a charged coupled device (CCD) camera for capturing still or moving images.

The power supply 714 can utilize common power management technologies such as replaceable and rechargeable batteries, supply regulation technologies, and/or charging system technologies for supplying energy to the components of the communication device 700 to facilitate long-range or short-range portable applications. Alternatively, or in combination, the charging system can utilize external power sources such as DC power supplied over a physical interface such as a USB port or other suitable tethering technologies.

The location receiver 716 can utilize location technology such as a global positioning system (GPS) receiver capable of assisted GPS for identifying a location of the communication device 700 based on signals generated by a constellation of GPS satellites, which can be used for facilitating location services such as navigation. The motion sensor 718 can utilize motion sensing technology such as an accelerometer, a gyroscope, or other suitable motion sensing technology to detect motion of the communication device 700 in three-dimensional space. The orientation sensor 720 can utilize orientation sensing technology such as a magnetometer to detect the orientation of the communication device 700 (north, south, west, and east, as well as combined orientations in degrees, minutes, or other suitable orientation metrics).

The communication device 700 can use the transceiver 702 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 706 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied, by the aforementioned components of the communication device 700.

Other components not shown in FIG. 7 can be used in one or more embodiments of the subject disclosure. For instance, the communication device 700 can include a reset button (not shown). The reset button can be used to reset the controller 706 of the communication device 700. In yet another embodiment, the communication device 700 can also include a factory default setting button positioned, for example, below a small hole in a housing assembly of the communication device 700 to force the communication device 700 to re-establish factory settings. In this embodiment, a user can use a protruding object such as a pen or paper clip tip to reach into the hole and depress the default setting button. The communication device 700 can also include a slot for adding or removing an identity module such as a Subscriber Identity Module (SIM) card. SIM cards can be used for identifying subscriber services, executing programs, storing subscriber data, and so forth.

The communication device 700 as described herein can operate with more or less of the circuit components shown in FIG. 7. These variant embodiments can be used in one or more embodiments of the subject disclosure.

The communication device 700 can be adapted to perform the functions of the set-top box 106, the display device 102, the viewing apparatuses 306, 308, and 310, the media processor 506, the media devices 508, or the portable communication devices 516 of FIG. 5. It will be appreciated that the communication device 700 can also represent other devices that can operate in system 100 of FIG. 1 and communication system 500 such as a gaming console and a media player. In addition, the controller 706 can be adapted in various embodiments to perform the functions 564 and 566, respectively.

Upon reviewing the aforementioned embodiments, it would be evident to an artisan with ordinary skill in the art that said embodiments can be modified, reduced, or enhanced without departing from the scope of the claims described below. For example, the system can provide that each viewing apparatus provides each user with their own specific content and advertising while overall presenting each viewer of the display device with a common media content presentation so that the overall common media content presentation is still completed in the same period of time for each user. Thus, in some embodiments, a time difference between the versions is computed and minimized by ensuring additional content does not cause an overly short or long version of the media content. Accordingly, each viewer can watch a customized version of the same event, TV show, concert, or movie, for example. Other embodiments can be used in the subject disclosure.

In addition, in other embodiments, use of the systems and methods described above can be used in devices and systems outside of a display device associated with viewing apparatuses. For example, in some embodiments, shared viewing of same media content can take place through a virtual retinal display. In an embodiment employing a virtual retina displays, each viewer can be provided their own custom viewing experience based on their user profiles. Similarly, in some embodiments, hypersound technology can be employed to direct custom sound to the ears of listeners according to their user profiles or preferences. Similarly, in some embodiments, ultrasound technology can be employed to direct custom sound to the ears of listeners according to their user profiles or preferences.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

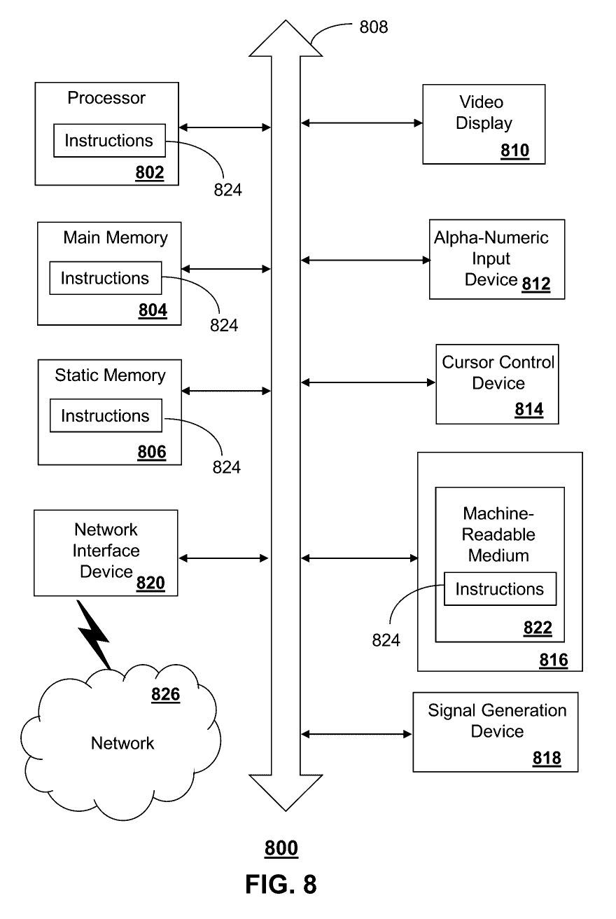

FIG. 8 depicts an exemplary diagrammatic representation of a machine in the form of a computer system 800 within which a set of instructions, when executed, may cause the machine to perform any one or more of the methods described above. One or more instances of the machine can operate, for example, as the directed content creator 530, the media processor 506, the set-top box 106, the display device 102, and viewing apparatuses 306, 308, and 310. In some embodiments, the machine may be connected (e.g., using a network 826) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 800 may include a processor (or controller) 802 (e.g., a central processing unit (CPU)), a graphics processing unit (GPU, or both), a main memory 804 and a static memory 806, which communicate with each other via a bus 808. The computer system 800 may further include a display unit 810 (e.g., a liquid crystal display (LCD), a flat panel, or a solid state display). The computer system 800 may include an input device 812 (e.g., a keyboard), a cursor control device 814 (e.g., a mouse), a disk drive unit 816, a signal generation device 818 (e.g., a speaker or remote control) and a network interface device 820. In distributed environments, the embodiments described in the subject disclosure can be adapted to utilize multiple display units 810 controlled by two or more computer systems 800. In this configuration, presentations described by the subject disclosure may in part be shown in a first of the display units 810, while the remaining portion is presented in a second of the display units 810.

The disk drive unit 816 may include a tangible computer-readable storage medium 822 on which is stored one or more sets of instructions (e.g., software 824) embodying any one or more of the methods or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 822 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 800.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, the method comprising:
detecting, by a media processor comprising a processor, a plurality of viewing devices in communication with a display device;
transmitting, by the media processor, a synchronization signal to a first viewing device of the plurality of viewing devices and a second viewing device of the plurality of viewing devices;
configuring, by the media processor, the display device to present a first data stream viewable only by the first viewing device;
configuring, by the media processor, the display device to present a second data stream viewable only by the second viewing device, wherein the first data stream and the second data stream have overlapping presentation schedules on the display device;
obtaining, by the media processor, first media content for the first viewing device and second media content for the second viewing device, wherein the first media content and the second media content comprise a same media program;
adjusting, by the media processor, the first media content to generate first personalized content provided to the display device for presentation to the first viewing device; and
adjusting, by the media processor, the second media content to generate second personalized content provided to the display device for presentation to the second viewing device, wherein the first personalized content and the second personalized content no longer comprise the same media program.

2. The method of claim 1, wherein a viewing of the first data stream by the first viewing device is separated from the viewing of the second data stream by the second viewing device by presenting the first data stream at the display device during a first time slot and presenting the second data stream at the display device during a second time slot, wherein the first time slot differs from the second time slot.

3. The method of claim 1, wherein a viewing of the first data stream by the first viewing device is separated from the viewing of the second data stream by the second viewing device by presenting the first data stream at the display device utilizing a first polarization scheme and presenting the second data stream at the display device utilizing a second polarization scheme, wherein the first polarization scheme differs from the first polarization scheme.

4. The method of claim 1, further comprising transmitting wirelessly first audio content to the first viewing device and transmitting wirelessly second audio content to the second viewing device.

5. The method of claim 4, wherein the presenting the first audio content is based on the first personalized content, and wherein the first audio content differs from the second audio content.

6. The method of claim 4, wherein the presenting the second audio content is based on the second personalized content, and wherein the second audio content differs from the first audio content.

7. The method of claim 1, wherein the first personalized content presented at the first viewing device comprises first advertising content selected according to a first viewer profile associated with a first user of the first viewing device, and wherein the second personalized content presented at the second viewing device comprises second advertising content selected according to a second viewer profile associated with a second user of the second viewing device.

8. The method of claim 7, wherein the first advertising content and the second advertising content are selected to fit into a same advertisement segment during presentation of the first personalized content and the second personalized content.

9. The method of claim 1, further comprising:
obtaining a preference of a user of the first viewing device; and
adjusting, according to the preference of the user, an audio aspect, a visual aspect, or both of the display device for presenting the first personalized content.

10. The method of claim 1, further comprising:
obtaining a preference of a user of the second viewing device; and
adjusting, according to the preference of the user, a an audio aspect, a visual aspect, or both of the display device for presenting the second personalized content.

11. An apparatus, comprising:
a processor; and
a memory that stores executable instructions that, when executed by the processor, facilitate performance of operations, comprising:
transmitting a synchronization signal to a first viewing apparatus and a second viewing apparatus, wherein the synchronization signal enables the first viewing apparatus to present a first presentation viewable only by a first user of the first viewing apparatus and enables the second viewing apparatus to present a second presentation viewable only by a second user of the second viewing apparatus;
adapting a display device to present a first data stream viewable only by the first viewing apparatus;
adapting the display device to present a second data stream viewable only by the second viewing apparatus, and wherein the first and the second data streams are provided simultaneously to the display device;
obtaining first personalized content for the first viewing apparatus according to a first viewer profile of the first user and second personalized content for the second viewing apparatus according to a second viewer profile of the second user, wherein the first personalized content and the second personalized content differ from each other;
providing the first personalized content to the display device for presentation at the first viewing apparatus; and
providing the second personalized content to the display device for presentation at the second viewing apparatus.

12. The apparatus of claim 11, wherein a viewing of the first data stream by the first viewing apparatus is separated from the viewing of the second data stream by the second viewing apparatus by presenting the first data stream at the display device during a first time slot and presenting the second data stream at display device during a second time slot, wherein the first time slot differs from the second time slot.

13. The apparatus of claim 11, wherein a viewing of the first data stream by the first viewing apparatus is separated from the viewing of the second data stream by the second viewing apparatus by presenting the first data stream at the display device utilizing a first polarization scheme and presenting the second data stream at display device utilizing a second polarization scheme, wherein the first polarization scheme differs from the first polarization scheme.

14. The apparatus of claim 11, wherein the operations further comprise presenting first audio content to the first viewing apparatus and presenting second audio content to the second viewing apparatus.

15. The apparatus of claim 11, wherein the operations further comprise:
providing the display device first advertising content selected according to the first viewer profile associated with the first user of the first viewing apparatus; and
providing the display device second advertising content selected according to the second viewer profile associated with the second user of the second viewing apparatus.

16. The apparatus of claim 15, wherein the first advertising content and the second advertising content are presented at a same advertisement time slot shared by the first personalized content and the second personalized content, and wherein the first advertising content differs from the second advertising content.

17. A machine-readable storage medium, comprising executable instructions that, when executed by a processor, facilitate performance of operations, comprising:
configuring a display device to present a first data stream viewable only by a first viewer;
configuring the display device to present a second data stream viewable only by a second viewer, wherein the first data stream and the second data stream have concurrent presentation schedules on the display device; and
obtaining first personalized content according to a first behavior profile of the first viewer and second personalized content according to a second behavior profile of the second viewer, wherein the first personalized content differs from the second personalized content.

18. The machine-readable storage medium of claim 17, wherein a viewing of the first data stream is viewable only by the first viewer by presenting the first data stream at the display device during a first time slot and presenting the second data stream at display device during a second time slot, wherein the first time slot and the second time slot do not overlap.

19. The machine-readable storage medium of claim 17, wherein a viewing of the first data stream is viewable by only the first viewer by presenting the first data stream at the display device utilizing a first polarization scheme and presenting the second data stream at the display device utilizing a second polarization scheme, wherein the first polarization scheme differs from the first polarization scheme.

20. The machine-readable storage medium of claim 17, wherein the operations further comprise presenting first audio content that can only be heard by the first viewer and presenting second audio content that can only be heard by the second viewer.
